(19) United States
(12) Patent Application Publication
(10) Pub. No.: US 2025/0189961 A1
(43) Pub. Date: Jun. 12, 2025

(54) DYNAMIC ASSET MAINTENANCE MANAGEMENT

(71) Applicant: INTERNATIONAL BUSINESS MACHINES CORPORATION, Armonk, NY (US)

(72) Inventors: Zhuo Zhao, Beijing (CN); Li Bo Zhang, Beijing (CN); Na Lv, Changping (CN); Yang Yang, SHANGHAI (CN); Guo Fang Yin, Shanghai (CN)

(21) Appl. No.: 18/532,589

(22) Filed: Dec. 7, 2023

(51) Int. Cl. G05B 23/02

(52) U.S. Cl. CPC G05B 23/0275; G05B 23/024; G05B 23/0272

(57) ABSTRACT

Embodiments sense an abnormal event, locate an abnormal asset within a context awareness map, build a comprehensive problem statement based on outputs from the asset contextual reactive model and a correlation and context machine learning model, the context awareness map, and data from the equipment topology, run a plurality of remedies for at least one candidate solution, and provide a recommended solution based on running the plurality of remedies for the at least one candidate solution.

### BACKGROUND

Aspects of the present invention relate generally to dynamically maintaining assets.

In an enterprise asset management industry, maintenance occurs when one or more assets have parameters that show abnormal values. Further, assets which have parameters that show abnormal values may affect other assets within an entire network.

### SUMMARY

In a first aspect of the invention, there is a computer-implemented method including: sensing, by a processor set, an abnormal event in an equipment topology; locating, by the processor set, an abnormal asset within a context awareness map; creating, by the processor set, an asset contextual reactive model for the located abnormal asset based on a work order history and domain knowledge; building, by the processor set, a comprehensive problem statement based on outputs from the asset contextual reactive model and a correlation and context machine learning model, the context awareness map, and data from sensors in the equipment topology; running, by the processor set, a plurality of remedies for at least one candidate solution based on the asset contextual reactive model and the comprehensive problem statement; and providing, by the processor set, a recommended solution based on running the plurality of remedies for the at least one candidate solution.

In another aspect of the invention, there is a computer program product including one or more computer readable storage media having program instructions collectively stored on the one or more computer readable storage media. The program instructions are executable to: sense an abnormal event in an equipment topology; locate an abnormal asset within a context awareness map; creating an asset contextual reactive model for the located abnormal asset based on a work order history and domain knowledge; build a comprehensive problem statement based on outputs from the asset contextual reactive model and a correlation and context machine learning model, the context awareness map, and data from sensors in the equipment topology; run a plurality of remedies for at least one candidate solution based on the asset contextual reactive model and the comprehensive problem statement; and provide a recommended solution based on running the plurality of remedies for the at least one candidate solution.

In another aspect of the invention, there is a system including a processor set, one or more computer readable storage media, and program instructions collectively stored on the one or more computer readable storage media. The program instructions are executable to: sense an abnormal event in an equipment topology; locate an abnormal asset within a context awareness map; create an asset contextual reactive model for the located abnormal asset based on a work order history and domain knowledge; build a comprehensive problem statement based on outputs from the asset contextual reactive model and a correlation and context machine learning model, the context awareness map, and data from sensors in the equipment topology; search for the at least one candidate solution based on the comprehensive problem statement; run a plurality of remedies for the at least one candidate solution based on the asset contextual reactive model and the comprehensive problem statement; and provide a recommended solution based on running the plurality of remedies for the at least one candidate solution.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an example of an internet of things (IoT) equipment topology in accordance with aspects of the present invention.

FIG. 4 shows a flowchart of an exemplary method in accordance with aspects of the present invention.

FIG. 5 shows a flowchart of an exemplary method in accordance with aspects of the present invention.

FIG. 6 shows an example of the asset contextual reactive model in accordance with aspects of the present invention.

FIG. 7 shows an example of a computing interface and an operation troubleshooting guide in accordance with aspects of the present invention.

FIG. 8 shows a flowchart of an exemplary method in accordance with aspects of the present invention.

FIG. 9 shows an example of upstream assets and downstream assets within the IoT equipment topology and the generated comprehensive problem statement in accordance with aspects of the present invention.

FIG. 10 shows a flowchart of an exemplary method in accordance with aspects of the present invention.

FIG. 11 shows an example of training the correlation and context machine learning model in accordance with aspects of the present invention.

FIG. 12 shows an example of executing the correlation and context machine learning model in accordance with aspects of the present invention.

FIG. 13 shows a block diagram of executing the correlation and context machine learning model in accordance with aspects of the present invention.

### DETAILED DESCRIPTION

In a first aspect of the present invention, there is a computer-implemented method including: sensing, by a processor set, an abnormal event in an equipment topology; locating, by the processor set, an abnormal asset within a context awareness map; creating, by the processor set, an asset contextual reactive model for the located abnormal asset based on a work order history and domain knowledge; building, by the processor set, a comprehensive problem statement based on outputs from the asset contextual reactive model and a correlation and context machine learning model, the context awareness map, and data from sensors in the equipment topology; running, by the processor set, a plurality of remedies for at least one candidate solution based on the asset contextual reactive model and the comprehensive problem statement; and providing, by the processer set, a recommended solution based on running the plurality of remedies for the at least one candidate solution. In particular, embodiments of the present invention may recommend accurate solutions based on historical knowledge and accumulated maintenance knowledge.

The computer-implemented method may include finding a location of the abnormal asset corresponding with the abnormal event; and identifying a correlation and context of a failure related to the abnormal event based on the asset contextual reactive model and the correlation and context machine learning model. In particular, embodiments of the present invention may provide an improved correlation and context of a failure related to the abnormal event and the location of the abnormal event.

The computer-implemented method may include collecting a running situation for the located abnormal event and searching for the at least one candidate solution based on the comprehensive problem statement. In particular, embodiments of the present invention may provide an accurate running situation of the located abnormal event and an improved candidate solution based on the comprehensive problem statement.

The computer-implemented method may include creating the context awareness map to model the equipment topology; simulating a target asset based on the contextual reactive model and the comprehensive problem statement; and validating the target asset based on the contextual reactive model and the comprehensive problem statement. The computer implemented-method may also include the equipment topology including an internet of things (IoT) equipment topology. In particular, embodiments of the present invention may provide an improved simulation and validation of the target asset and an IoT equipment topology.

The computer-implemented method may include filtering out at least one incorrect solution from the at least one candidate solution and storing the recommended solution as feedback data for the work order history. In particular, embodiments of the present invention may filter out incorrect solutions to improve accuracy and provide feedback data to improve predictive accuracy.

The computer-implemented method may include storing the recommended solution as training data for the asset contextual reactive model and the correlation and context machine learning model; creating the correlation and context machine learning model based on the context awareness map, the work order history, an operation troubleshooting guide, and feedback, and the operation troubleshooting guide including a symptom of the failure, a cause of the failure, and a potential remedy of the failure. In particular, embodiments of the present invention may store the improved recommended solution for training data to improve predictive accuracy and the improved operation troubleshooting guide including the system, cause, and remedy of the failure.

The computer-implemented method may include the comprehensive problem including a plurality of assets and a description of the abnormal values of the assets. In particular, embodiments of the present invention may include an improved comprehensive problem which includes assets and a description of the abnormal values of the assets.

In a second aspect of the present invention, there is a computer program product including program instructions executable to: sense an abnormal event in an equipment topology; locate an abnormal asset within a context awareness map; create an asset contextual reactive model for the located abnormal asset based on a work order history and domain knowledge; build a comprehensive problem statement based on outputs from the asset contextual reactive model and a correlation and context machine learning model, the context awareness map, and data from sensors in the equipment topology; run a plurality of remedies for at least one candidate solution based on the asset contextual reactive model and the comprehensive problem statement; and provide a recommended solution based on running the plurality of remedies for the at least one candidate solution. In particular, embodiments of the present invention may recommend accurate solutions based on historical knowledge and accumulated maintenance knowledge.

The computer program product may include finding a location of the abnormal asset corresponding with the abnormal event; and identifying a correlation and context of a failure related to the abnormal event based on the asset contextual reactive model and the correlation and context machine learning model. In particular, embodiments of the present invention may provide an improved correlation and context of a failure related to the abnormal event and the location of the abnormal event.

The computer program product may include collecting a running situation for the located abnormal event and searching for the at least one candidate solution based on the comprehensive problem statement. In particular, embodiments of the present invention may provide an accurate running situation of the located abnormal event and an improved candidate solution based on the comprehensive problem statement.

The computer program product may include creating the context awareness map to model the equipment topology; simulating a target asset based on the contextual reactive model and the comprehensive problem statement; and validating the target asset based on the contextual reactive model and the comprehensive problem statement. The computer program product may also include the equipment topology including an internet of things (IoT) equipment topology. In particular, embodiments of the present invention may provide an improved simulation and validation of the target asset and an IoT equipment topology.

The computer program product may include filtering out at least one incorrect solution from the at least one candidate solution; storing the recommended solution as training data for the asset contextual reactive model and the correlation and context machine learning model and feedback data for the work order history; and creating the correlation and context machine learning model based on the context awareness map, the work order history, an operation troubleshooting guide, and feedback. In particular, embodiments of the present invention may filter out incorrect solutions to improve accuracy and provide feedback data to improve predictive accuracy.

In a third aspect of the present invention, there is a system including program instructions executable to: sense an abnormal event in an equipment topology; locate, an abnormal asset within a context awareness map; create an asset contextual reactive model for the located abnormal asset based on a work order history and domain knowledge; build a comprehensive problem statement based on outputs from the asset contextual reactive model and a correlation and context machine learning model, the context awareness map, and data from sensors in the equipment topology; run a plurality of remedies for at least one candidate solution based on the asset contextual reactive model and the comprehensive problem statement; and provide a recommended solution based on running the plurality of remedies for the at least one candidate solution. In particular, embodiments of the present invention may recommend accurate solutions based on historical knowledge and accumulated maintenance knowledge.

Aspects of the present invention relate generally to dynamically maintaining assets. Embodiments of the present invention provide an improved mean time to repair (MTTR) in comparison to conventional systems. Embodiments of the present invention provide an improved first time fix rate (FTFR) in comparison to conventional systems. Embodiments of the present invention provide a cheap, efficient, and safe solution to fixing issues in asset management. Embodiments of the present invention also provide an improvement to an entire system of asset management in comparison to conventional systems which only focus on a specific asset. Aspects of the present invention propagate validation patterns to a production environment to improve an unplanned work ratio (UWR) and issues related to a service level agreement (SLA) in comparison to conventional systems. In further embodiments of the present invention, by propagating validations patterns to the production environment, costs can be saved in comparison to conventional systems which do not implement validations patterns.

Embodiments of the present invention also provide enterprise asset management, mobility, and industry models by managing asset management and monitoring and detecting anomalies in an asset management system. Aspects of the present invention provide artificial intelligence (AI) monitoring, inspection, and predictive maintenance to predict failures. Embodiments of the present invention also provide flexibility by deploying the dynamic asset management system across a multi-cloud environment. Embodiments of the present invention provide visual anomaly detection, prescriptive assistance, and actional insights for worker safety in the asset management system. Aspects of the present invention also improve a cost of re-work during incidents, warranty work, and recalls in an asset management system in comparison to conventional systems. Embodiments of the present invention also improve a cost of downtime in comparison to conventional systems.

Aspects of the present invention create a context awareness map which models an Internet of things (IoT) equipment topology. Embodiments of the present invention also create an asset contextual reactive model based on a work order history and domain knowledge. Aspects of the present invention also identify a correlation and context of possible failures in an asset management system based on sensing of abnormal events and model outputs. Embodiments of the present invention build comprehensive problem solutions based on identified failure correlation and context within the context awareness map. Aspects of the present invention also perform validation by applying propagated solutions based on the asset contextual reactive model and the context awareness map.

Embodiments of the present invention provide a computer-implemented method, a system, and a computer program product for dynamically maintaining assets within an asset management system. In contrast, conventional systems merely detect abnormal events, but are not able to describe an entire problem clearly and include important keywords. Further, conventional systems merely focus on abnormalities and failures with a specific asset, but are not able to determine related equipment that may fail or may have abnormalities and failures that affect an entire network. Conventional systems also use a large amount of work orders and solutions, which make it difficult to store and track historical working records with respect to previous solutions to abnormalities. Also, conventional systems may assign the large amount of work orders to different technicians, which involve large costs due to duplicative work. Therefore, conventional systems have difficulty to improve MTTR and FTFR, have a low efficiency, inconsistent maintenance quality, and have low historical knowledge sharing from experienced technicians. In contrast, embodiments of the present invention provide improved MTTR and FTFR in comparison to conventional systems. Further, embodiments of the present invention extend an asset and a network lifecycle in comparison to conventional systems. Embodiments of the present invention also propagate validations patterns to improve the UWR and issues related to the SLA in comparison to conventional systems. Embodiments of the present invention also utilize machine learning (ML) to improve predictive maintenance over time and utilize historical knowledge with respect to abnormalities and corresponding solutions.

Embodiments of the present invention include a highly computationally efficient system, method, and computer program product for dynamically maintaining a plurality of assets in a network and providing feedback for predictive maintenance. Accordingly, implementations of the present invention provide an improvement (i.e., technical solution) to a problem arising in the technical field of providing asset management in a network topology. In particular, embodiments of the present invention resolve an abnormal event in a network topology based on historical data, domain knowledge, and IoT equipment topology. Embodiments of the present invention also use ML to train a plurality of models which provide real-time predictive maintenance over time using historical knowledge and real-time data of abnormalities and corresponding solutions.

Implementations of the present invention are necessarily rooted in computer technology. For example, the step of training a machine learning (ML) model to improve predictive accuracy of maintenance solutions is computer-based and cannot be performed in the human mind. Training and building a plurality of ML models is, by definition, performed by a computer and cannot practically be performed in the human mind (or with pen and paper) due to the complexity and massive amounts of calculations involved. For example, training and building the plurality of ML models in embodiments of the present invention may use machine learning to build and train the ML model using historical work data, domain knowledge, and IoT equipment topology to improve the predictive accuracy of maintenance solutions. In particular, training and building the plurality of ML models performs a large amount of processing of historical work data, domain knowledge, IoT equipment topology, and modeling of parameters to train the ML models such that the ML models generate and outputs in real time (or near real time). Given the scale and complexity of processing historical work data, domain knowledge, IoT equipment topology, and modeling of parameters, it is simply not possible for the human mind, or for a person using pen and paper, to perform the number of calculations involved in training and/or building the ML models.

Aspects of the present invention include a method, system, and computer program product for dynamically maintaining assets in response to an abnormal event. For example, a computer-implemented method includes: creating a context awareness map to model Internet of things (IoT) topology and locating an abnormal asset within the IoT topology; creating an asset contextual reactive model based on work order history and domain knowledge and using machine learning to identify a correlation and context of an abnormal event corresponding to the abnormal asset; building a comprehensive program statement with all upstream to downstream correlated and contextual assets within a running situation based on the correlation and the context of the abnormal event; collect a changed running situation according to the created asset contextual reactive model and the context awareness map; obtaining comprehensive problem solutions based on the identified failure correlation and context of the context awareness map; running remedies, simulating, and validating by applying propagated solutions based on the asset contextual reactive model and the context awareness map for each of the comprehensive problem solutions; terminating the simulation and recording a solution in response to a problem being solved; terminating the simulation and escaping the solution in response to the problem not being solved; and providing feedback based on a result to improve a machine learning model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamic asset management code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

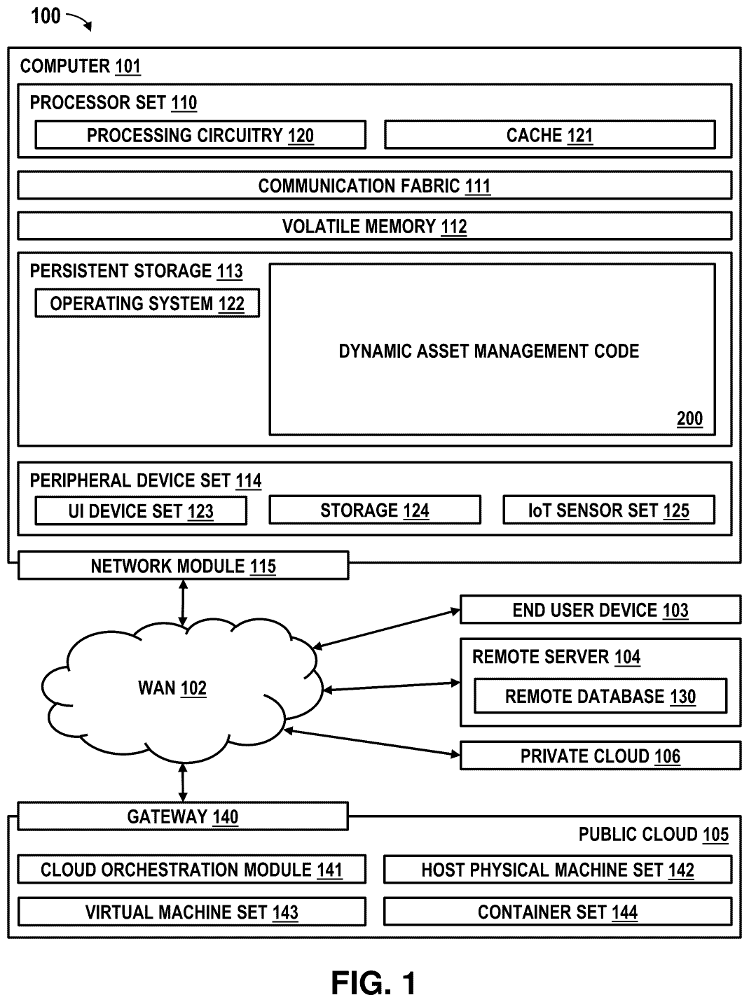

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

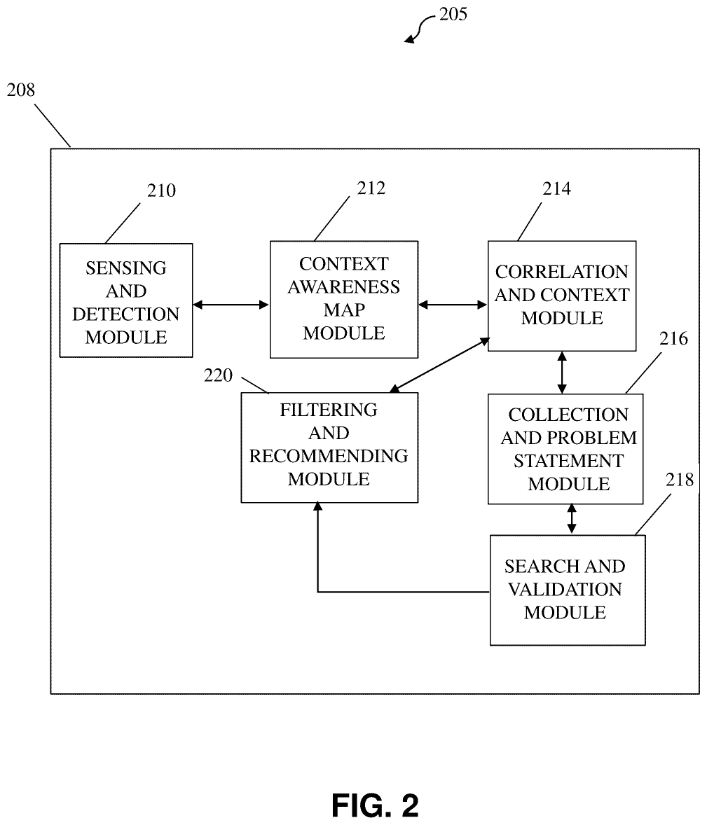

FIG. 2 shows a block diagram of an exemplary environment 205 in accordance with aspects of the present invention. In embodiments, the environment 205 includes an asset management server 208, which may comprise one or more instances of the computer 101 of FIG. 1. In other examples, the asset management server 208 comprises one or more virtual machines or one or more containers running on one or more instances of the computer 101 of FIG. 1.

In embodiments, the asset management server 208 of FIG. 2 comprises a sensing and detection module 210, a context awareness map module 212, a correlation and context module 214, a collection and problem statement module 216, a search and validation module 218, and a filtering and recommending module 220, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The asset management server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, the sensing and detection module 210 senses a trigger from an abnormal event using at least one sensor in an IoT equipment topology and generates an error message and description for the abnormal event. In aspects of the present invention, the IoT equipment topology comprises a plurality of assets with a corresponding plurality of sensors. For example, the assets may include at least one water tank, at least one parallel multistage pump, a steam turbine, a dynamo, a condenser, and a transformer. However, embodiments are not limited to this example such that the IoT equipment topology can include different assets within a manufacturing plant. In embodiments, the sensing and detection module 210 also finds an abnormal asset in an IoT equipment topology which corresponds with the triggered abnormal event. In embodiments, the sensing and detection module 210 sends the abnormal asset which corresponds with triggered abnormal event to the context awareness map module 212.

In accordance with aspects of the present invention, the context awareness map module 212 creates a context awareness map to model the IoT equipment topology in response to the context awareness map not being created. In embodiments, the context awareness module 212 locates the abnormal asset which corresponds with the triggered abnormal event from the context awareness map. The context awareness map module 212 then sends an identifier corresponding to the located abnormal asset to the correlation and context module 214.

In accordance with aspects of the present invention, the correlation and context module 214 receives the identifier corresponding to the located abnormal asset and creates an asset contextual reactive model for the located abnormal asset which is based on work order history and domain knowledge. In embodiments, in response to the asset contextual reactive model already being created, the correlation and context module 214 further builds the asset contextual reactive model for the located abnormal asset based on the work order history and the domain knowledge. In further embodiments, the asset contextual reactive model is trained and built using machine learning based on the work order history, the domain knowledge, and the located abnormal asset. The asset contextual reactive model is configured to change a set of input parameters (e.g., a temperature, a rotational speed, and an acoustic vibration of an asset) and determine an impact to all of the assets in the IoT equipment topology.

In accordance with aspects of the present invention, the correlation and context module 214 also creates a correlation and context machine learning model. In embodiments, the correlation and context module 214 creates the correlation and context machine learning model based on the context awareness map, the work order history, an operation troubleshooting guide, and feedback from a technician. In further embodiments, the correlation and context machine learning model is trained and built using machine learning based on the context awareness map, the work order history, the operation troubleshooting guide, and the feedback from the technician. In embodiments, the correlation and context machine learning model is used to improve accuracy of abnormal event detection. In further embodiments, the correlation and context machine learning model can be executed (i.e., run) to create a correlation and context scope which lists a plurality of assets which have possible failures in the IoT equipment topology based on the located abnormal asset. For example, if the located abnormal asset has the abnormal event, other assets that are upstream and downstream of the located abnormal asset may also have potential failures (i.e., other abnormal events) based on the abnormal event. The correlation and context module 214 may identify the correlation and the context of a failure related to the abnormal event and sends the identified correlation and the context of the failure related to the abnormal event to the collection and problem statement module 216. In embodiments, the correlation and context module 214 identifies the correlation and context of the failure related to the abnormal event based on the outputs of the asset contextual reactive model and the correlation and context machine learning model.

With continued reference to FIG. 2, and in accordance with aspects of the present invention, the collection and problem statement module 216 receives the identified correlation and the context of the failure related to the abnormal event and collects a running situation for the located abnormal asset which corresponds with the abnormal event. For example, the collection and problem statement module 216 may determine other assets that are upstream and downstream of the located abnormal assets which may have potential failures based on the abnormal event using an output of the correlation and context machine learning model. The collection and problem statement module 216 may also determine an impact on the other assets in the IoT equipment topology from the abnormal event using an output of the asset contextual reactive model.

In accordance with aspects of the present invention, the collection and problem statement module 216 builds a comprehensive problem statement using the outputs from the correlation and context machine learning model and the asset contextual reactive model, the context awareness map, and data from a plurality of sensors in the IoT equipment topology. In embodiments, the collection and problem statement module 216 initially filters out all assets which are working properly based on the outputs from the correlation and context machine learning model and the asset contextual reactive model, the context awareness map, and data from a plurality of sensors in the IoT equipment topology. Then, the collection and problem statement module 216 filters out all normal attributes for the assets which have abnormal events. In this manner, the collection and problem statement module 216 identifies the abnormal attributes (i.e., abnormal parameters) for the assets which have abnormal events. The collection and problem statement module 216 then sorts the assets which have abnormal events from an upstream portion of the IoT equipment topology to a downstream portion of the IoT equipment topology. In other words, the collection and problem statement module 216 lists the assets which have abnormal events in an order in which upstream assets are listed before assets which are further downstream of the IoT equipment topology. The collection and problem statement module 216 then outputs the comprehensive problem statement to the search and validation module 218.

Still referring to FIG. 2, in accordance with aspects of the present invention, the search and validation module 218 searches for at least one candidate solution based on the received comprehensive problem statement. In embodiments, the search and validation module 218 searches for the at least one candidate solution from at least one of the internet, an intranet (i.e., a private network used by an organization of the asset management), and a work order management system. The search and validation module 218 then runs remedies for the at least one candidate solution and simulating and validating a target asset based on the contextual reactive model. In particular, the search and validation module 218 finds the target asset for simulating and validating the at least one candidate solution and determines a current running situation from the asset contextual reactive model. The search and validation module 218 then applies the at least one candidate solution to the target asset and collects a changed running solution change based on the asset contextual reactive model. As stated above, the asset contextual reactive model is able to change a set of input parameters (e.g., the applied at least one candidate solution) for the target asset and determine an impact to all of the assets in the IoT equipment topology based on the changed set of input parameters.

In embodiments, the search and validation module 218 also determines whether there is an impact to other assets besides the target asset in the IoT equipment topology using the asset contextual reactive model, the work order history, and the domain knowledge. The search and validation module 218 updates a running situation for all impacted assets in the IoT equipment topology in an upstream to downstream order in response to determining that there is an impact to other assets besides the target asset. The search and validation module 218 then goes to a next step of determining whether the problem is resolved.

In embodiments, the search and validation module 218 also determines whether the problem is resolved in response to determining that there is no impact to other assets besides the target asset. The search and validation module 218 terminates a simulation and validation and stores the at least one candidate solution in response to a determination that the problem has been resolved. The search and validation module 218 also sends the at least one candidate solution as a recommended solution to the filtering and recommending module 220 in response to the determination that the problem has been resolved. The search and validation module 218 determines whether there is a next step in response to determining that the problem has not been resolved.

In embodiments, the search and validation module 218 also terminates the simulation and validation and escapes the at least one candidate solution in response to determining that there is no next step. The search and validation module 218 also sends the at least one candidate solution as an incorrect solution to the filtering and recommending module 220 in response to the determination that there is no next step. The search and validation module 218 then loops back to finding another target asset and repeats the steps for resolving the problem in response to determining that there is another step.

In accordance with aspects of the present invention, the filtering and recommending module 220 receives the at least one solution as either the recommended solution or the incorrect solution. In embodiments, the filtering and recommending module 220 filters out the at least one solution as the incorrect solution because the remedy to the target asset was not successful. The filtering and recommending module 220 may provide the at least one solution as the recommended solution as feedback for the work order history and training data for the asset contextual reactive model and the correlation and context machine learning model because the remedy to the target asset was successful. In this manner, the filtering and recommending module 220 provides the at least one solution as the recommended solution as feedback to ensure that the asset management server 208 provides continuous improvement and learning to improve the accuracy of predictive maintenance.

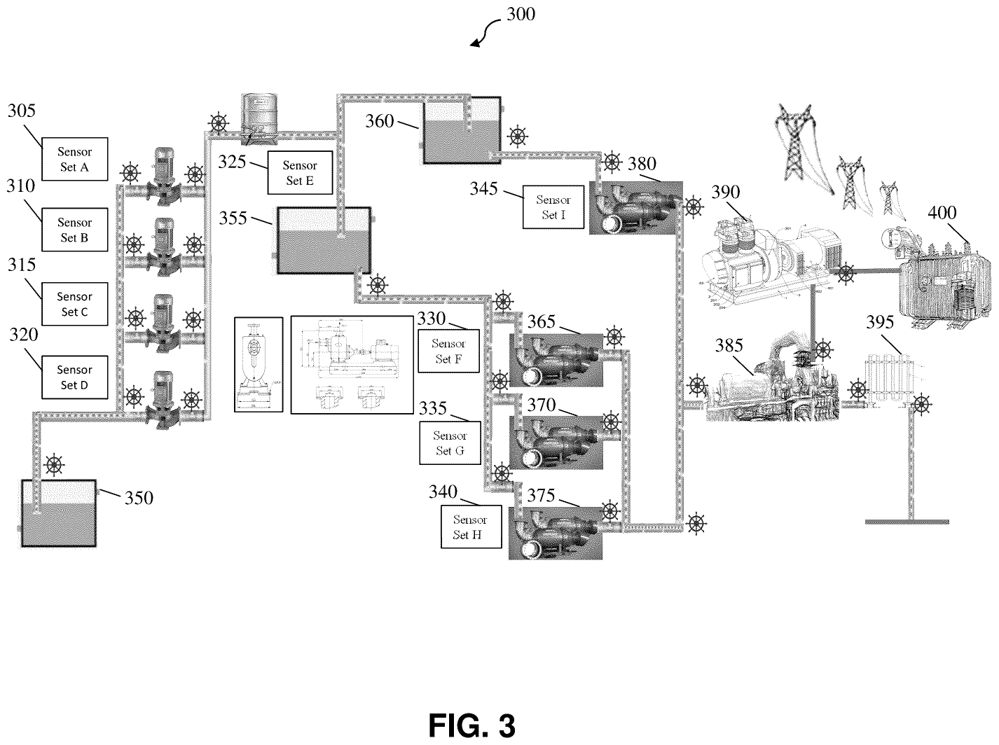

FIG. 3 shows a block diagram of an example of an IoT equipment topology in accordance with aspects of the present invention. In embodiments, the IoT equipment topology 300 represents a thermal power plant which includes a plurality of sensor sets 305, 310, 315, 320, 325, 330, 335, 340, and 345 (e.g., sensor sets A-I). In further embodiments, the assets of the IoT equipment topology include water tanks 350, 355, and 360, parallel multistage pumps 365, 370, 375, and 380, a steam turbine 385, a dynamo 390, a condenser 395, and a transformer 400. Although embodiments of the present invention may be described with reference to elements of the thermal power plant in FIG. 3, embodiments are not limited to this example. In particular, the asset management server 208 of FIG. 2 may be configured to work with any IoT equipment topology 300 of any asset management system (e.g., automotive, heavy equipment, computing infrastructure, plant equipment, etc.)

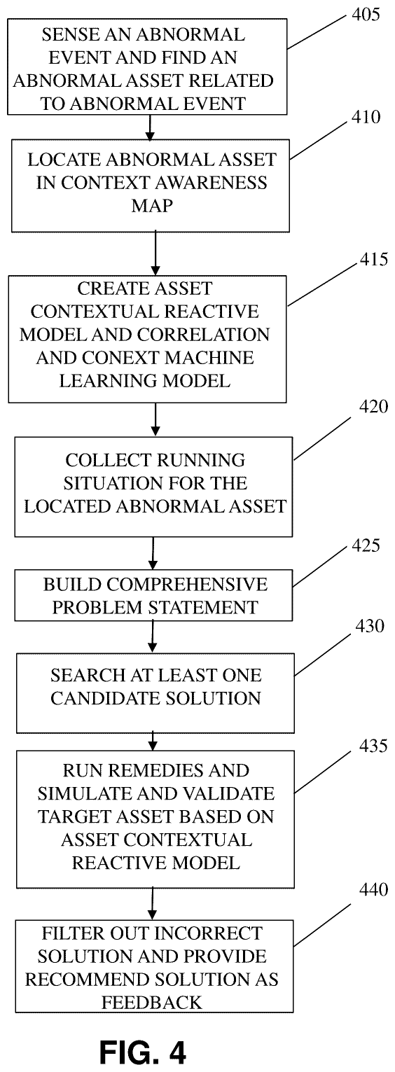

FIG. 4 shows a flowchart of an exemplary method in accordance with aspects of the present invention. Steps of the method may be carried out in the environment of FIG. 2 and are described with reference to elements depicted in FIG. 2.

At step 405, the system senses, at the sensing and detection module 210, a trigger from an abnormal event and finds an abnormal asset related to the abnormal event. In embodiments and as described with FIG. 2, the sensing and detection module 210 sends an identifier of the abnormal asset which corresponds with the triggered abnormal event to the context awareness map module 212.

At step 410, the system locates, at the context awareness map module 212, the abnormal asset which corresponds with the triggered abnormal event from the context awareness map. In embodiments and as described with FIG. 2, the context awareness map module 212 sends the located abnormal asset to the correlation and context module 214.

At step 415, the system creates, at the correlation and context module 214, an asset contextual reactive model and a correlation and context machine learning model. In embodiments and as described with FIG. 2, the correlation and context module 214 creates the asset contextual reactive model for the located abnormal asset which is based on work order history and domain knowledge. In other embodiments and as described with FIG. 2, the correlation and context module 214 creates the correlation and context machine learning model based on the context awareness map, the work order history, an operation troubleshooting guide, and feedback from a technician.

At step 420, the system collects, at the collection and problem statement module 216, a running situation for the located abnormal asset which corresponds with the abnormal event. In embodiments and as described with FIG. 2, the collection and problem statement module 216 collects the running situation based on the asset contextual reactive model and the correlation and context machine learning model. In further embodiments, the running situation comprises a description of parameters of the abnormal event and the located abnormal asset.

At step 425, the system builds, at the collection and problem statement 216, a comprehensive problem statement using the outputs from the correlation and context machine learning model, the asset contextual reactive model, the context awareness map, and data from a plurality sensors in the IoT equipment topology. In embodiments and as described with FIG. 2, the collection and problem statement module 216 outputs the comprehensive problem statement to the search and validation module 218.

At step 430, the system searches, at the search and validation module 218, for at least one candidate solution based on the received comprehensive problem statement. In embodiments, and as described with FIG. 2, the search and validation module 218 searches for the at least one candidate solution from at least one of the Internet, the Intranet, and a work order management system.

At step 435, the system runs, at the search and validation module 218, a plurality of remedies for the at least one candidate solution and simulates and validates a target asset based on the asset contextual reactive model. In embodiments, and as described with FIG. 2, the search and validation module 218 runs the remedies and simulates and validates the target asset using the at least one candidate solution based on the asset contextual reactive model.

At step 440, the system filters out, at the filtering and recommending module 220, the at least one solution as the incorrect solution and provides the at least one solution as the recommended solution as feedback because the remedy to the target assets was successful. In embodiments, and as described with FIG. 2, the filtering and recommending module 220 filters out the at least one solution as the incorrection solution because the remedy to the target asset was not successful. In further embodiments, the filtering and recommending module 220 provides the at least one solution as the recommended solution because the remedy to the target was successful.

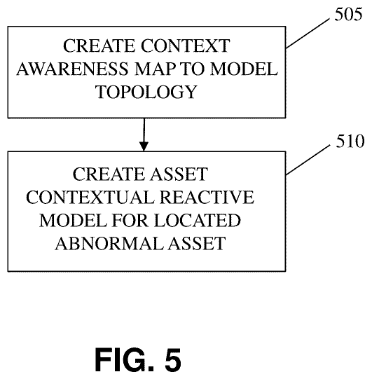

FIG. 5 shows flowchart of another exemplary method in accordance with aspects of the present invention. Steps of the method may be carried out in the environment of FIG. 2 and are described with reference to elements depicted in FIG. 2.

At step 505, the system creates, at the context awareness map module 212, a context awareness map to model the IoT equipment topology. In embodiments and as described with FIG. 2, the context awareness map module 212 locates an abnormal asset which corresponds with a triggered abnormal event from the context awareness map. In further embodiments, the context awareness map module 212 sends the located abnormal asset to the correlation and context module 214.

At step 510, the system creates, at the correlation and context module 214, an asset contextual reactive model for the located abnormal asset. In embodiments and as described with respect to FIG. 2, the asset contextual reactive model is based on work order history and domain knowledge. In further embodiments, the asset contextual reactive model is trained and built using machine learning based on the work order history, the domain knowledge, and the located abnormal asset. The asset contextual reactive model is configured to change a set of input parameters (e.g., a temperature, a rotate speed, and an acoustic of an asset) and determine an impact to all of the assets in the IoT equipment topology.

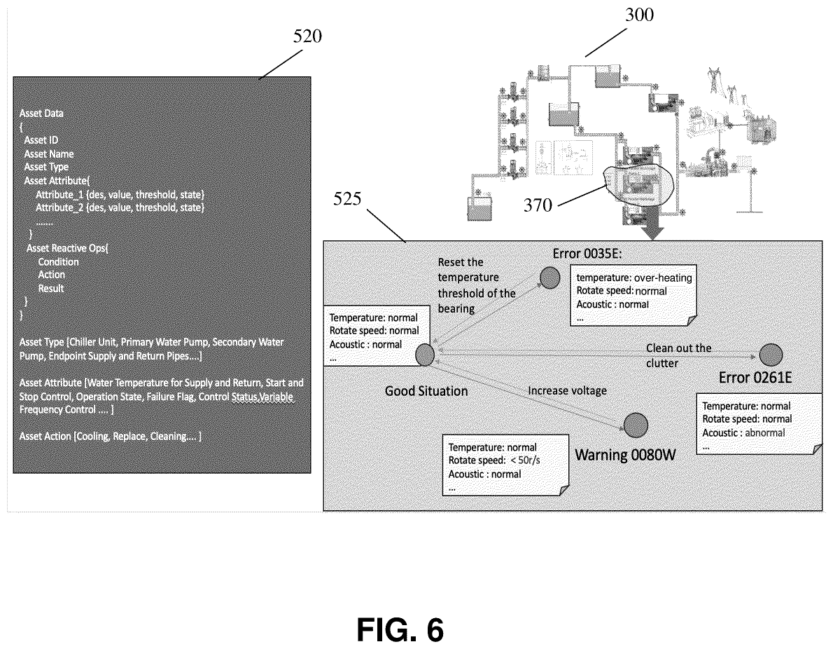

FIG. 6 shows an example of the asset contextual reactive model in accordance with aspects of the present invention. In embodiments, the asset contextual reactive model 520 includes a set of input parameters, such as a temperature, a rotational speed, and an acoustic vibration of the parallel multistage pump 370 (as indicated by the circle in the IoT equipment topology 300 of FIG. 6). For example, as shown in block 525, in response to a temperature threshold of a bearing of the parallel multistage pump 370 being changed (i.e., error 0035E), the temperature becomes over-heated (i.e., an abnormal value) and the rotate speed and the acoustic remains with a normal value. In another example, as shown in block 525, in response to a clutter being cleaned of the parallel multistage pump 370 (i.e., error 0261E), the acoustic has an abnormal value and the temperate and the rotate speed remains with a normal value. In another example, as shown in block 525, in response to a voltage of the parallel multistage pump 370 being increased (i.e., warning 0080W), the rotate speed becomes greater than 50 rotations/second (i.e., an abnormal value) and the temperature and acoustic remains with a normal value.

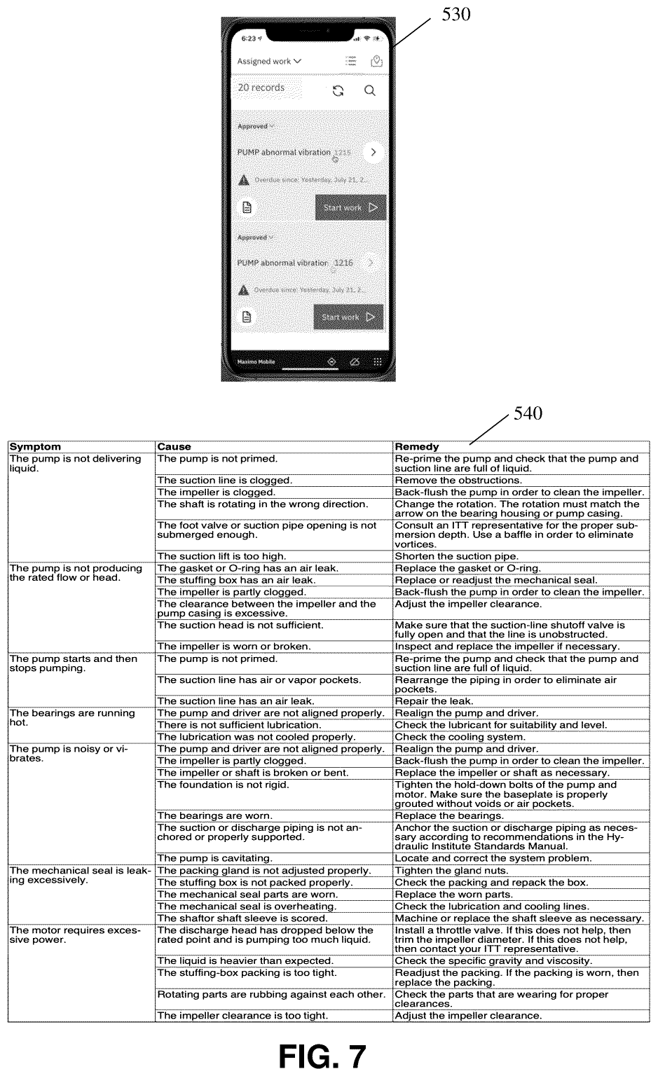

FIG. 7 shows an example of a computing interface and an operation troubleshooting guide in accordance with aspects of the present invention. In embodiments, the computing interface 530 is on a mobile device and communicates with the context awareness map which models the IoT equipment topology. In embodiments, the computing interface 530 displays a plurality of assets which have abnormal values (e.g., pump abnormal vibration 1215, pump abnormal vibration 1216, etc.).

In further embodiments, and with continued reference to FIG. 7, the operation troubleshooting guide 540 includes a symptom of a problem, a cause of a problem, and a potential remedy of the problem. The operation troubleshooting guide 540 is an example of the domain knowledge of the IoT equipment topology.

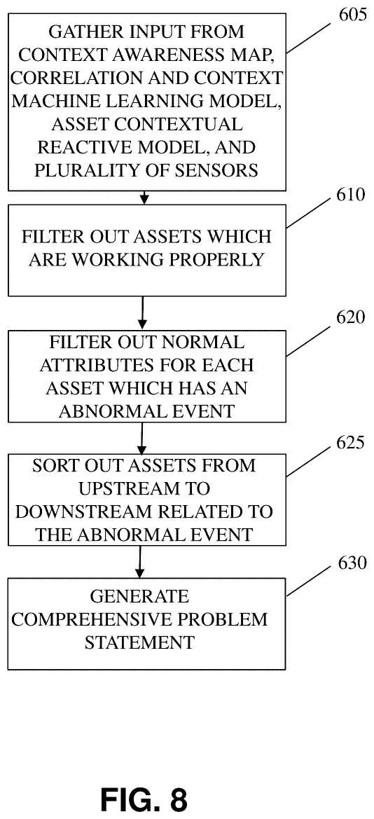

FIG. 8 shows flowchart of another exemplary method in accordance with aspects of the present invention. Steps of the method may be carried out in the environment of FIG. 2 and are described with reference to elements depicted in FIG. 2.

At step 605, the system gathers, at the collection and problem statement module 216, inputs from the context awareness map, the correlation and context machine learning model, the asset contextual reactive model, and data from a plurality of sensors in the IoT equipment topology.

At step 610, the system filters out, at the collection and problem statement module 216, assets which are working properly based on the context awareness map, the correlation and context machine learning model, the asset contextual reactive model, and data from a plurality of sensors in the IoT equipment topology.

At step 620, the system filters out, at the collection and problem statement module 216, normal attributes for each asset which have abnormal events. In embodiments and as described with reference to FIG. 2, the collection and problem statement module 216 includes the abnormal attributes for assets which have abnormal events. In embodiments, the system filters out assets which are working properly and normal attributes for each asset which have abnormal events

At step 625, the system sorts out, at the collection and problem statement module 216, the assets which have abnormal events from an upstream portion to a downstream portion within the IoT equipment topology. In embodiments, after the system filters out assets which are working properly and normal attributes for each asset which have abnormal events, the system sorts the assets which have abnormal events in a sorted order from an upstream portion to a downstream portion within the IoT equipment topology.

At step 630, the system generates, at the collection and problem statement module 216, the comprehensive problem statement. In embodiments and as described with reference to FIG. 2, the collection and problem statement module 216 outputs the comprehensive problem statement to the search and validation module 218.

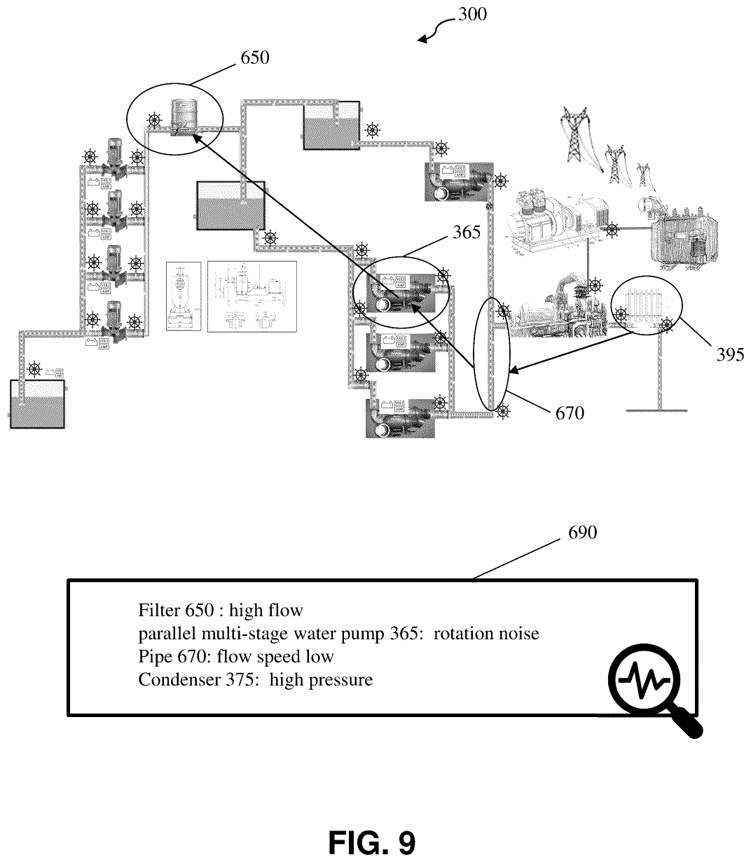

FIG. 9 shows an example of upstream assets and downstream assets within the IoT equipment topology and the generated comprehensive problem statement in accordance with aspects of the present invention. In the example shown in FIG. 9, the IoT equipment topology 300 includes the parallel multistage pump 365, an upstream asset 650 (e.g., filter 650) and downstream assets (e.g., a pipe 670 and the condenser 395). In this example, the upstream asset 650 is upstream with respect to the parallel multistage pump 365. Further, in embodiments, the downstream assets 395 and 670 are downstream with respect to the parallel multistage pump 365.

With continued reference to the example of FIG. 9, the collection and problem statement module 216 generates the comprehensive problem statement 690 which describes a plurality of assets (e.g., the filter 650, the parallel multi-stage water pump 365, the pipe 670, and the condenser 375) and a description of the abnormal values of the assets (e.g., high flow, rotation noise, flow speed low, and high pressure).

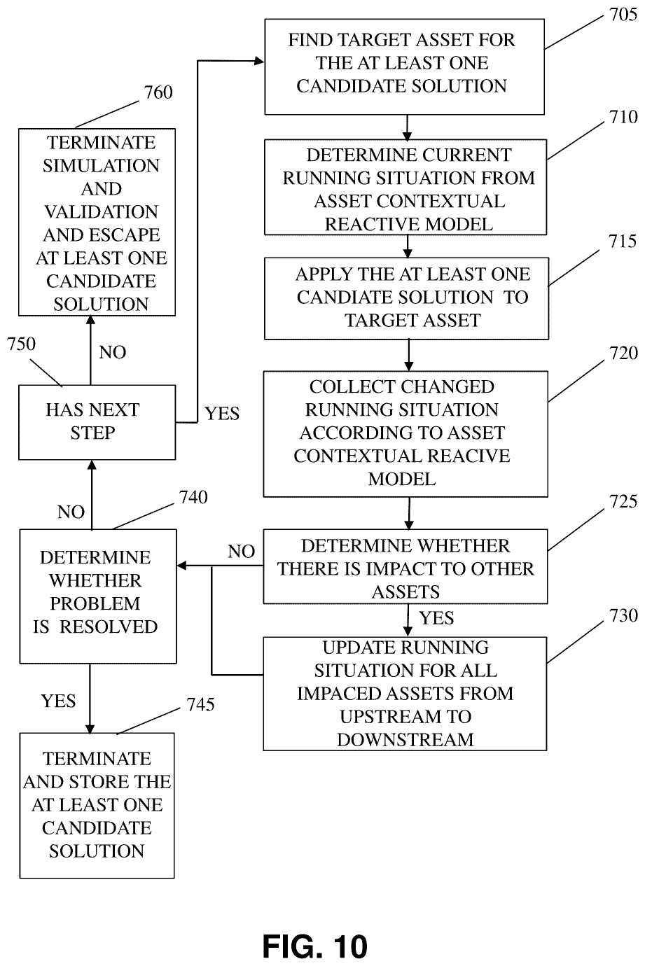

FIG. 10 shows a flowchart of another exemplary method in accordance with aspects of the present invention. Steps of the method may be carried out in the environment of FIG. 2 and are described with reference to elements depicted in FIG. 2.

At step 705, the system finds, at the search and validation module 218, a target asset for the at least one candidate solution. In embodiments and as described with respect to FIG. 2, the search and validation module 218 finds the target asset for simulating and validating the at least one candidate solution.

At step 710, the system determines, at the search and validation module 218, a current running situation from the asset contextual reactive model. At step 715, the system applies, at the search and validation module 218, the at least one candidate solution to the target asset. At step 720, the system collects, at the search and validation module 218, a changed running situation based on the asset contextual reactive model.

At step 725, the system determines, at the search and validation module 218, whether there is an impact to other assets besides the target asset in the IoT equipment topology. In embodiments and as described with respect to FIG. 2, the search and validation module 218 determines whether there is an impact to other assets besides the target asset in the IoT equipment topology using the asset contextual reactive model, the work order history, and the domain knowledge.

At step 730, the system updates, at the search and validation module 218, a running situation for all impacted assets in an update to downstream order in response to determining that there is an impact to other assets besides the target asset in the IoT equipment topology. Then, the method goes to step 740.

At step 740, the system determines, at the search and validation module 218, whether a problem is resolved in response to determine that there is no impact to other assets besides the target asset. At step 745, the system terminates, at the search and validation module 218, the simulation and validation and stores the at least one candidate solution in response to a determination that the problem has been resolved.

At step 750, the system determines, at the search and validation module 218, whether there is a next step in response to determining that the problem has not been resolved. At step 760, the system terminates, at the search and validation module 218, the simulation and validation and escapes the at least one solution in response to determining that there is no next step. The search and validation module 218 loops back to step 705 in response to determining that there is not another step.

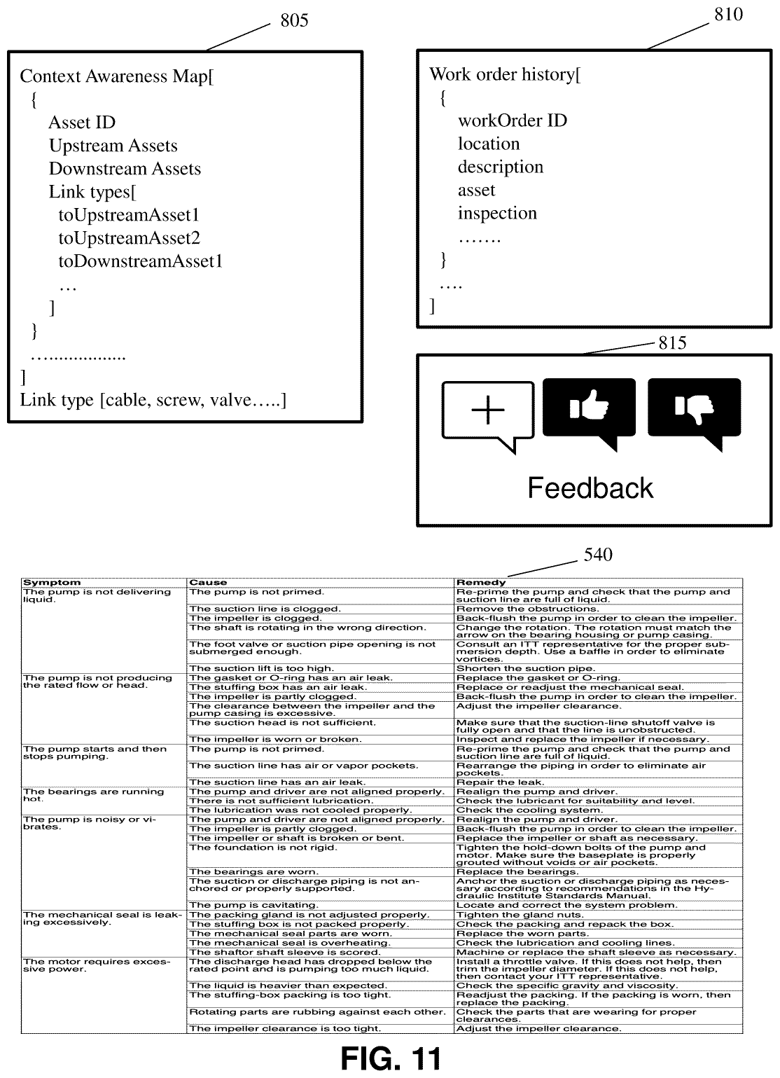

FIG. 11 shows an example of training the correlation and context machine learning model in accordance with aspects of the present invention. In embodiments, the correlation and context module 214 trains the correlation and context machine learning model using machine learning based on the context awareness map 805, the work order history 810, the operation troubleshooting guide 540, and the feedback 815 from the technician. The correlation and context module 214 trains the correlation and context machine learning model to improve accuracy of the abnormal event detection.

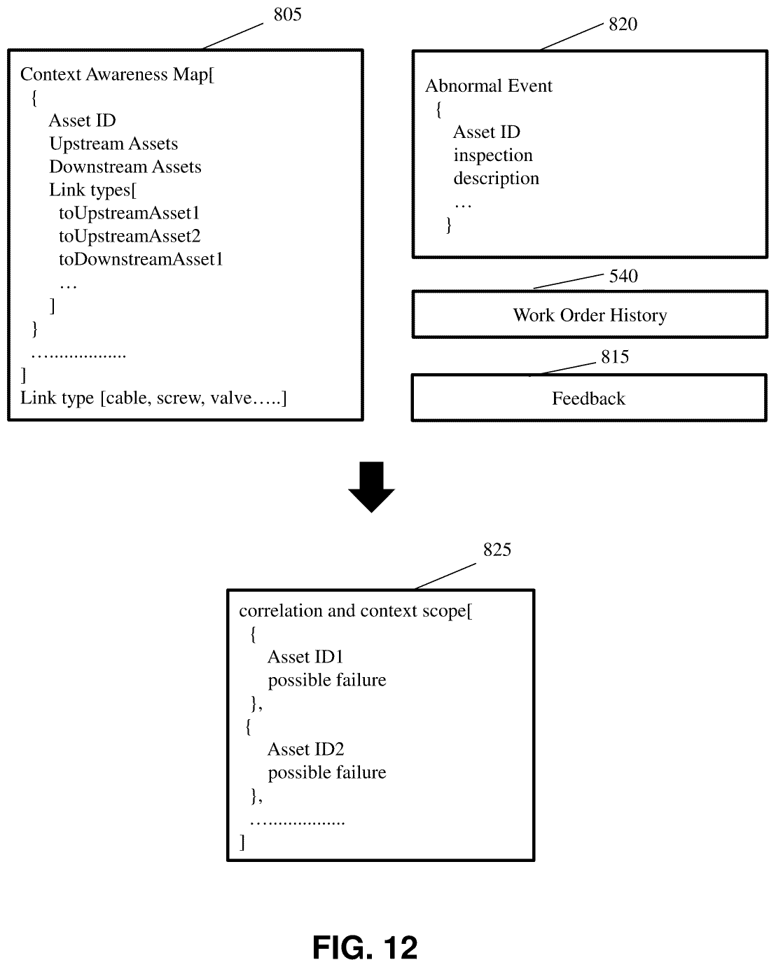

FIG. 12 shows an example of executing the correlation and context machine learning model in accordance with aspects of the present invention. In embodiments of FIG. 12, after the correlation and context machine learning model is trained using the context awareness map 805, the work order history 810, the operation troubleshooting guide 540, and the feedback 815 from the technician, the correlation and context module 214 executes (i.e., runs) the correlation and context machine learning model executes to create a correlation and context scope 825 which lists a plurality of assets which have possible failures in the IoT equipment topology 300 based on the located abnormal asset.

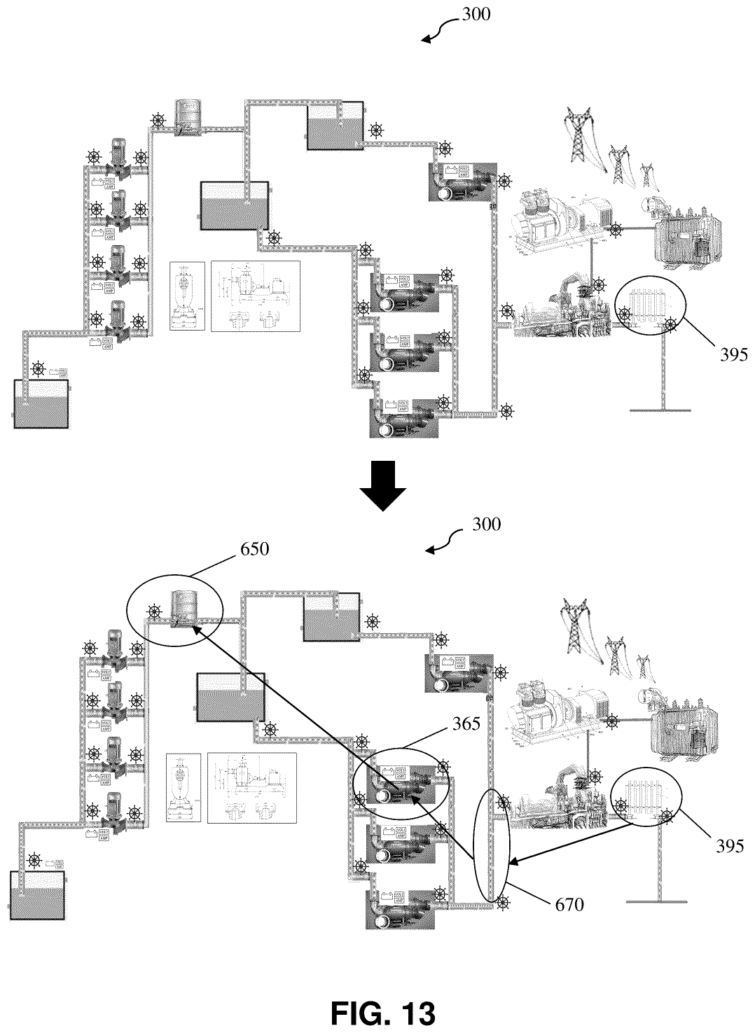

FIG. 13 shows a block diagram of executing the correlation and context machine learning model in accordance with aspects of the present invention. In embodiments of FIG. 13, the correlation and context module 214 executes the correlation and context machine learning model executes based on the located abnormal asset (i.e., the condenser 395) to determine other assets (e.g., the parallel multistage pump 365, the filter 650, and the pipe 670) which have possible failures in the IoT equipment topology 300 within the correlation and context scope 825.

In embodiments, the asset management server 208 is configured to be used in different scenarios. In an example, Alex works in a power company and is responsible for the maintenance of various asset of the power company. On a specific day, a condenser pressure of a power plant for the power company shows an abnormal value of over 100 psi. In the asset management server 208, a work order is automatically opened which describes a time when the problem occurred, an asset number of the condenser, and the description of the problem (the condenser pressure is over 100 psi). In this situation, Alex is assigned to solve the work order. The asset management server 208 automatically digs out useful information from a context awareness map, identifies the correlation and context from an asset contextual reactive model, and generates a comprehensive problem statement in response to the work order being automatically opened. Alex is able to utilize the asset management server 208 to search for at least one candidate solution from one of an internet, an intranet, and a work order management system. In particular, the asset management server 208 identifies a plurality of candidate solutions. The asset management server 208 then validates and applies a propagated solution for each candidate solution based on the asset contextual reactive model and the context awareness map. In this example, the asset management server 208 then ranks each of the plurality of candidate solutions based on the validation. Alex is able to use the asset management server 208 to apply a best solution to resolve the problem quickly and successfully. The asset management server 208 is then able to record and store the best solution in the work order management solution and send the best solution to the asset contextual reactive model and the correlation and context machine learning model for continuous predictive improvement.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
sensing, by a processor set, an abnormal event in an equipment topology;
locating, by the processor set, an abnormal asset within a context awareness map;
creating, by the processor set, an asset contextual reactive model for the located abnormal asset based on a work order history and domain knowledge;
building, by the processor set, a comprehensive problem statement based on outputs from the asset contextual reactive model and a correlation and context machine learning model, the context awareness map, and data from sensors in the equipment topology;
running, by the processor set, a plurality of remedies for at least one candidate solution based on the asset contextual reactive model and the comprehensive problem statement; and
providing, by the processor set, a recommended solution based on running the plurality of remedies for the at least one candidate solution.

2. The computer-implemented method of claim 1, further comprising:
finding a location of the abnormal asset corresponding with the abnormal event; and
identifying a correlation and context of a failure related to the abnormal event based on the asset contextual reactive model and the correlation and context machine learning model.

3. The computer-implemented method of claim 1, further comprising collecting a running situation for the located abnormal asset.

4. The computer-implemented method of claim 1, further comprising searching for the at least one candidate solution based on the comprehensive problem statement.

5. The computer-implemented method of claim 1, wherein the equipment topology comprises an Internet of Things (IoT) equipment topology.

6. The computer-implemented method of claim 1, further comprising:
creating the context awareness map to model the equipment topology;
simulating a target asset based on the contextual reactive model and the comprehensive problem statement; and
validating the target asset based on the contextual reactive model and the comprehensive problem statement.

7. The computer-implemented method of claim 1, further comprising filtering out at least one incorrect solution from the at least one candidate solution.

8. The computer-implemented method of claim 1, further comprising storing the recommended solution as feedback data for the work order history.

9. The computer-implemented method of claim 1, further comprising:
creating the correlation and context machine learning model based on the context awareness map, the work order history, an operation troubleshooting guide, and feedback;
storing the recommended solution as training data for the asset contextual reactive model and the correlation and context machine learning model.

10. The computer-implemented method of claim 9, wherein the operation troubleshooting guide comprises a symptom of the failure, a cause of the failure, and a potential remedy of the failure.

11. The computer-implemented method of claim 1, wherein the comprehensive problem statement comprises a plurality of assets and a description of the abnormal values of the assets.

12. A computer program product comprising one or more computer readable storage media having program instructions collectively stored on the one or more computer readable storage media, the program instructions executable to:
sense an abnormal event in an equipment topology;
locate an abnormal asset within a context awareness map;
create an asset contextual reactive model for the located abnormal asset based on a work order history and domain knowledge;
build a comprehensive problem statement based on outputs from the asset contextual reactive model and a correlation and context machine learning model, the context awareness map, and data from sensors in the equipment topology;
run a plurality of remedies for at least one candidate solution based on the asset contextual reactive model and the comprehensive problem statement; and
provide a recommended solution based on running the plurality of remedies for the at least one candidate solution.

13. The computer program product of claim 12, further comprising:
finding a location of the abnormal asset corresponding with the abnormal event; and
identifying a correlation and context of a failure related to the abnormal event based on the asset contextual reactive model and the correlation and context machine learning model.

14. The computer program product of claim 12, further comprising collecting a running situation for the located abnormal asset.

15. The computer program product of claim 12, further comprising searching for the at least one candidate solution based on the comprehensive problem statement.

16. The computer program product of claim 12, wherein the equipment topology comprises an Internet of Things (IoT) equipment topology.

17. The computer program product of claim 12, further comprising:
creating the context awareness map to model the equipment topology;
simulating a target asset based on the contextual reactive model and the comprehensive problem statement; and
validating the target asset based on the contextual reactive model and the comprehensive problem statement.

18. The computer program product of claim 12, further comprising filtering out at least one incorrect solution from the at least one candidate solution.

19. The computer program product of claim 12, further comprising:
creating the correlation and context machine learning model based on the context awareness map, the work order history, an operation troubleshooting guide, and feedback;
storing the recommended solution as training data for the asset contextual reactive model and the correlation and context machine learning model and feedback data for the work order history.

20. A system comprising:
a processor set, one or more computer readable storage media, and program instructions collectively stored on the one or more computer readable storage media, the program instructions executable to:
sense an abnormal event in an equipment topology;
locate an abnormal asset within a context awareness map;
create an asset contextual reactive model for the located abnormal asset based on a work order history and domain knowledge;
build a comprehensive problem statement based on outputs from the asset contextual reactive model and a correlation and context machine learning model, the context awareness map, and data from sensors in the equipment topology;
searching for at least one candidate solution based on the comprehensive problem statement;
run a plurality of remedies for the at least one candidate solution based on the asset contextual reactive model and the comprehensive problem statement; and
provide a recommended solution based on running the plurality of remedies for the at least one candidate solution.
